(19) United States
(12) Patent Application Publication
(10) Pub. No.: US 2012/0235468 A1
(43) Pub. Date: Sep. 20, 2012

(54) BICYCLE HUB AND BICYCLE WHEEL COMPRISING THE SAME

(76) Inventor: James CHANG, (US)

(21) Appl. No.: 13/415,969

(22) Filed: Mar. 9, 2012

(30) Foreign Application Priority Data
Mar. 15, 2011 (TW) 100108710

(51) Int. Cl. B60B 27/00

(52) U.S. Cl. 301/110.5

(57) ABSTRACT

A bicycle hub of the present invention comprises two discs, an axial portion, and a connecting portion. The discs are formed with a through hole individually. The axial portion comprises a first end, a second end, and a middle section. The first and the second end of the axial portion penetrate the through hole of one of the discs individually. The connecting portion connects between two discs. The connecting portion defines at least an open portion so that at least a part of the middle section of the axial portion is not enclosed and can be seen. As such, the connecting portion of the present invention defines the open portion so that the connecting portion incompletely encloses the middle section of the axial portion. Whereby the connecting portion not only saves material, but reduces the weight of the bicycle hub.

### BACKGROUND OF THE INVENTION

1. Field of the Invention

The present invention relates to a bicycle hub, more particularly to a bicycle hub which is installed on a bicycle wheel.

2. Description of the Prior Art

The common structure of a bicycle hub, such as disclosed in U.S. Pat. No. 4,602,822, includes a shaft housing, a shaft, and two hub disc housings. The shaft housing is secured between the hub disc housings so that the hub disc housings are in an operative relationship with each other. The shaft penetrates through the through holes of the hub disc housings and the axial bore of the shaft housing. The shaft housing covers the shaft completely so that the shaft can not be seen at all. Each of the hub disc housings is formed with a plurality of spoke holes being adapted for a spoke of a bicycle wheel penetrating therethrough. Hereby the conventional bicycle hub is able to rotate about an axis with respect to the shaft and drive the bicycle wheel to rotate. However, in order to cope with the market requirements, the manufacturers try hard to improve the structure of bicycle hub especially reducing the weight of the bicycle hub.

The present invention is, therefore, arisen to obviate or at least mitigate the above mentioned disadvantages.

### SUMMARY OF THE INVENTION

The main object of the present invention is to provide a lightweight bicycle hub.

To achieve the above and other objects, a bicycle hub of the present invention comprises two discs, an axial portion, and a connecting portion.

The discs are formed with a through hole individually. Each disc is formed with a plurality of spoke holes. Each spoke hole is used for a spoke of a bicycle wheel penetrating therethrough.

The axial portion comprises a first end, a second end, and a middle section located between the first and the second end. The first and the second end of the axial portion penetrate the through hole of one of the discs individually so that each disc is able to rotate about an axis with respect to the axial portion.

The connecting portion connects between two discs so that the discs are in an operative relationship with each other. The connecting portion is disposed at outside of the middle section of the axial portion. And the connecting portion defines at least an open portion so that the connecting portion incompletely encloses the middle section of the axial portion, that is, at least a part of the middle section of the axial portion is not enclosed and can be seen.

As such, the connecting portion of the bicycle hub of the present invention defines the open portion so that the connecting portion incompletely encloses the middle section of the axial portion. Whereby the connecting portion of the bicycle hub of the present invention not only saves material, but reduces the weight of the bicycle hub.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a preferred embodiment of the present invention;

FIG. 2 is a breakdown drawing showing a preferred embodiment of the present invention;

FIG. 3 is a cross-sectional view showing a preferred embodiment of the present invention.

### DETAILED DESCRIPTION OF THE PREFERRED EMBODIMENTS

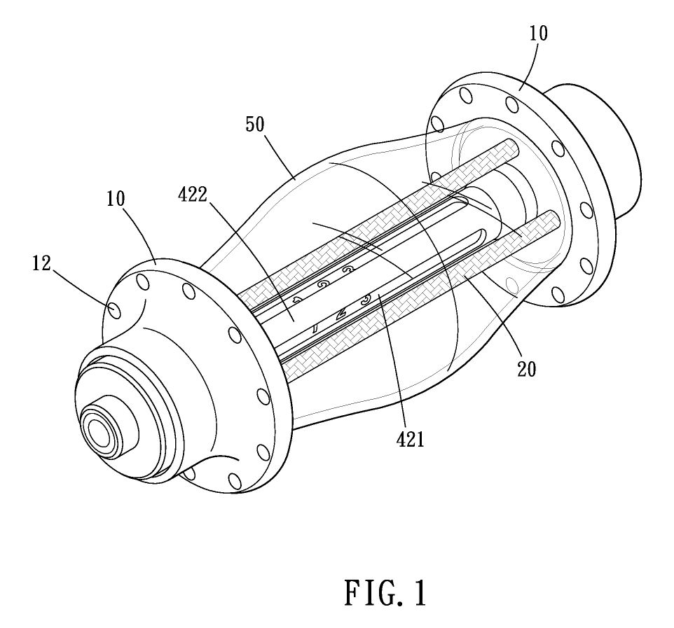

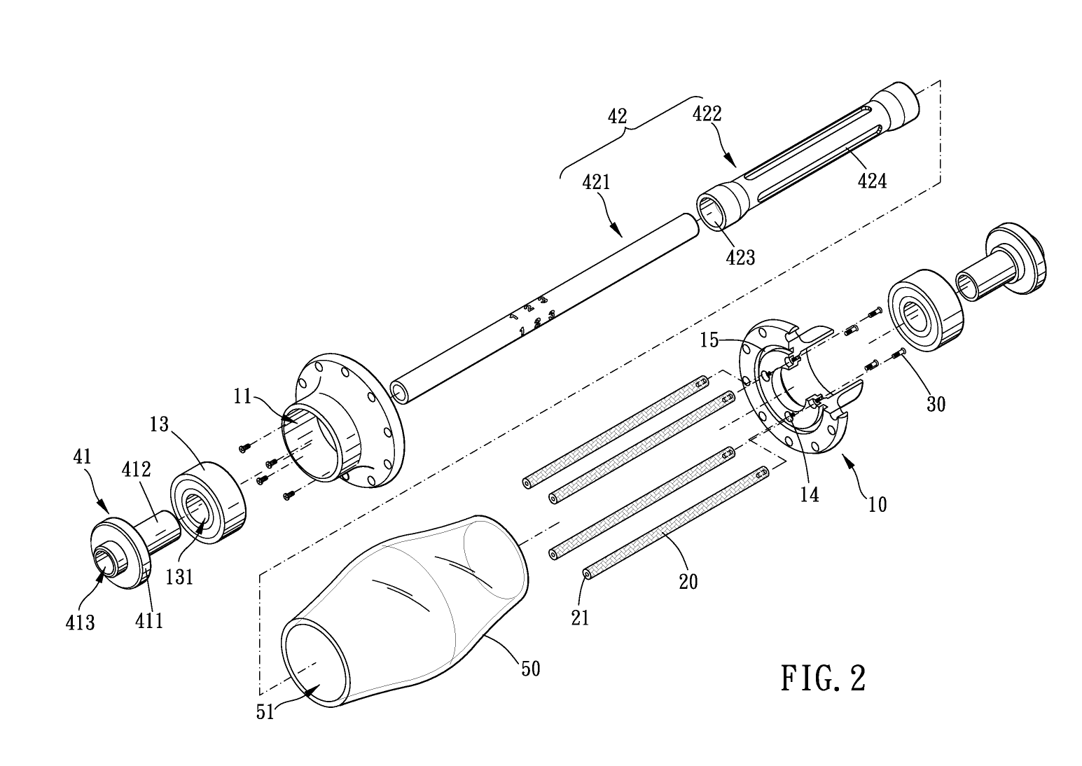

Please refer to FIG. 1 and FIG. 2 for a preferred embodiment of the present invention. The bicycle hub of the present embodiment comprises two discs 10, at least two connecting portions 20, a plurality of threaded members 30, an axial portion, and a transparent cover 50. The number of threaded members 30 corresponds to the number of the connecting portions 20.

Each disc is formed with a through hole 11. Each disc is further formed with a plurality of spoke holes 12. Each spoke hole 12 is used for a spoke of a bicycle wheel penetrating therethrough (not shown). Each disc comprises a bearing 13 disposed in the through hole 11 thereof. Each bearing has a penetrating hole 131.

The connecting portions 20 connect between the discs 10. Preferably, two ends of each of the connection portions are secured in the discs so that the discs are in an operative relationship with each other. In the preferred embodiment, the bicycle hub comprises four connecting portions 20. The connecting portions 20 are rod-shaped and spaced from one another. More specifically, each disc comprises a plurality of engaging recesses 14. The number of engaging recesses 14 corresponds to the number of connecting portions 20. Two ends of each of the connecting portions 20 are secured in one of corresponding engaging recesses 14 respectively. Two ends of each of the connecting portions 20 are formed with a threaded hole 21 respectively. Each threaded member 30 penetrates one of the engaging recesses 14 and threads in the threaded hole 21 of one end of each connecting portion 20 so that each disc 10 and each connecting portion 20 are secured with each other. Preferably, the connecting portions 20 are made of carbon fiber.

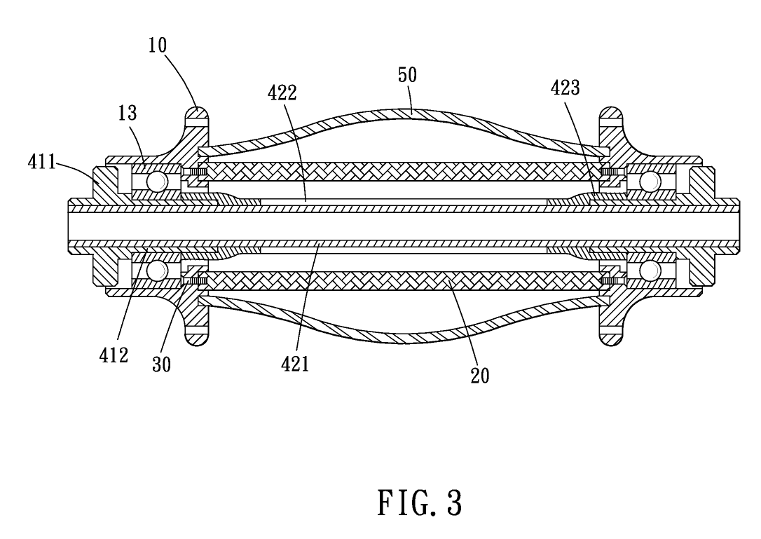

Please refer to FIG. 2 and FIG. 3. Two ends of the axial portion are disposed in the discs 10 respectively. Each disc 10 is able to rotate about an axis with respect to the axial portion. Wherein the connecting portions 20 define at least an open portion so that at least a part of the axial portion is not enclosed and can be seen. More definitely, the axial portion comprises a first end, a second end, and a middle section. The middle section is located between the first and the second end. The first and the second end of the axial portion penetrate the through hole 11 of one of the discs individually so that each disc is able to rotate about the axis with respect to the axial portion. The connecting portions 20 are disposed at outside of the middle section of the axial portion. And the connecting portions 20 incompletely enclose the middle section of the axial portion so that at least a part of the middle section of the axial portion is not enclosed and can be seen. More specifically, in the present embodiment, the four rod-shaped connecting portions 20 are spaced from one another so as to define the open portion between the connecting portions 20. That is, the connecting portions 20 incompletely enclose the middle section of the axial portion.

Preferably, the axial portion comprises two caps 41 and a spindle 42. Each cap 41 comprises a larger diameter section 411 and a smaller diameter section 412. An outer diameter of the larger diameter section 411 is larger than an inner diameter of the smaller diameter section 412. The smaller diameter section 412 of each cap 41 penetrates the through hole 11 of one of the discs 10 and the penetrating hole 131 of one of the bearings 13. Two ends of the spindle 42 are secured in one of the caps 41 individually. In the preferred embodiment, each cap 41 is formed with a fixing hole 413. The spindle 42 comprises a rod 421 and a tube 422. The tube 422 is formed with two inserting grooves 423 and an aperture. The inserting grooves are located at one end of the tube respectively. The aperture communicates between the inserting grooves 423. The smaller diameter section 412 of each cap 41 inserts into and is secured in one of the inserting grooves 423. The rod 421 penetrates through the inserting grooves 423 and the aperture. Two ends of the rod 421 penetrate through and are secured in the fixing hole 413 of one of the caps individually. Preferably, an outer surface of the tube 422 is formed with at least an opening 424 in communication with the aperture so that an outer surface of the rod 421 is not enclosed and can be seen.

Please refer to FIG. 1 and FIG. 2. The transparent cover 50 is disposed between the discs 10 and defines a receiving space 51. More clearly, each disc is annularly formed with an abutting recess 15. Two ends of the transparent cover 50 abut the abutting recess 15 of one of the discs respectively so that the connecting portions 20 and the spindle 42 are received in the receiving space 51.

The bicycle hub of the present invention is adapted to install in a bicycle wheel (not shown) and functions as a wheel hub of the wheel. In addition to the bicycle wheel comprises the bicycle hub of the present invention, it further comprises a wheel rim and a plurality of spokes. The spokes connect the wheel rim to the discs so that the wheel rim is in an operative relationship with each disc. As such, the connecting portions 20 of the bicycle hub of the present invention define the open portion so that the connecting portions 20 incompletely enclose the middle section of the axial portion. And the connecting portions 20 are made of carbon fiber. In contrast to the conventional bicycle hub, its connecting portion is formed with a hollow channel in its axle center only. The hollow channel is adapted for the conventional bicycle hub's shaft penetrating therethrough. The connecting portion of the conventional bicycle hub encloses and covers the middle section of the shaft completely so that the connecting portion does not have any open portion. The middle section of the shaft can not be seen at all. Whereby the connecting portions 20 of the bicycle hub of the present invention not only savesmaterial, but reduce the weight of the bicycle hub. Additionally, in the preferred embodiment of the bicycle hub of the present invention, four connecting portions 20 are carbon fiber rods so as to further reduce the weight of the bicycle hub.

Moreover, when two ends of the spindle 42 are secured in the caps 41 respectively and assemble a whole axial portion, an intermediate portion of the spindle 42 is located at the open portion defined by the connecting portions 20 so that consumers can see the spindle 42 direct. When manufacturers sell the bicycle hub of the present invention, they can take advantage of the feature, the outer surface of the rod 421 is not enclosed so as to be exposed from the opening 424 of the tube 422 and can be seen, to produce various spindles 42. For example, the outer surface of the rod 421 and the outer surface of the tube 422 can apply different colors. Or indicating their trademarks on the outer surface of the rod 421. Or providing all kinds of spindles 42 to consumers when they want to buy a new spindle 42 instead of the old one. The bicycle hub of the present invention is able to cause the consumers to notice and buy it and enhance its market competitiveness.

In addition, the transparent cover, which is disposed between the discs, not only prevents dust from entering the receiving space, but is adapted for consumers seeing through it to the appearance of the spindle 42 and the connecting portions 20. Moreover, styles of the transparent cover 50 are changeable so that consumers have many choices to decorate the bicycle hub of the present invention.

What is claimed is:

1. A bicycle hub, comprising:
two disc, formed with a through hole individually, each disc being formed with a plurality of spoke holes, each spoke hole being used for a spoke of a bicycle wheel penetrating therethrough;
an axial portion, comprising a first end, a second end, and a middle section located between the first and the second end, the first and the second end of the axial portion penetrating the through hole of one of the discs individually so that each disc is able to rotate about an axis with respect to the axial portion;
a connecting portion, connecting between two discs so that the discs are in an operative relationship with each other, the connecting portion being disposed at outside of the middle section of the axial portion, and the connecting portion incompletely enclosing the middle section of the axial portion so that at least a part of the middle section of the axial portion is not enclosed and can be seen.

2. The bicycle hub of claim 1, wherein the axial portion comprises two caps and a spindle, each cap comprises a larger diameter section and a smaller diameter section, the smaller diameter section of each cap penetrates the through hole of one of the discs, two ends of the spindle are secured in one of the caps individually.

3. The bicycle hub of claim 2, wherein each cap is formed with a fixing hole, the spindle comprises a rod, two ends of the rod penetrate through and are secured in the fixing hole of one of the caps individually.

4. The bicycle hub of claim 3, wherein the spindle comprises a tube, the tube is formed with two inserting grooves and an aperture, the inserting grooves are respectively located at one end of the tube, the aperture communicates between the inserting grooves, the smaller diameter section of each cap inserts into and is secured in one of the inserting grooves, the rod penetrates through the inserting grooves and the aperture.

5. The bicycle hub of claim 4, wherein an outer surface of the tube is formed with at least an opening in communication with the aperture so that an outer surface of the rod is not enclosed and can be seen.

6. The bicycle hub of claim 1, wherein the bicycle hub comprises four connecting portions, the connecting portions are rod-shaped and spaced from one another.

7. The bicycle hub of claim 1, wherein the bicycle hub further comprises a transparent cover, the transparent cover is disposed between the discs and defines a receiving space.

8. The bicycle hub of claim 2, wherein the bicycle hub further comprises a transparent cover, the transparent cover is disposed between the discs and defines a receiving space.

9. The bicycle hub of claim 3, wherein the bicycle hub further comprises a transparent cover, the transparent cover is disposed between the discs and defines a receiving space.

10. The bicycle hub of claim 4, wherein the bicycle hub further comprises a transparent cover, the transparent cover is disposed between the discs and defines a receiving space.

11. The bicycle hub of claim 5, wherein the bicycle hub further comprises a transparent cover, the transparent cover is disposed between the discs and defines a receiving space.

12. The bicycle hub of claim 6, wherein the bicycle hub further comprises a transparent cover, the transparent cover is disposed between the discs and defines a receiving space.

13. The bicycle hub of claim 1, wherein the connecting portion is made of carbon fiber.

14. The bicycle hub of claim 2, wherein the connecting portion is made of carbon fiber.

15. The bicycle hub of claim 3, wherein the connecting portion is made of carbon fiber.

16. The bicycle hub of claim 4, wherein the connecting portion is made of carbon fiber.

17. The bicycle hub of claim 5, wherein the connecting portion is made of carbon fiber.

18. The bicycle hub of claim 6, wherein the connecting portions are made of carbon fiber.

19. A bicycle wheel, comprising the bicycle hub of claim 1, the bicycle wheel further comprising a wheel rim and a plurality of spokes, the spokes connecting the wheel rim to the discs so that the wheel rim is in an operative relationship with each disc.
